(19) United States
(12) Patent Application Publication
(10) Pub. No.: US 2026/0274202 A1
(43) Pub. Date: Sep. 17, 2026

(54) WEBBING TAKE-UP DEVICE

(71) Applicant: KABUSHIKI KAISHA TOKAI-RIKA-DENKI-SEISAKUSHO, Aichi-ken (JP)

(72) Inventors: Yuta SUZUKI, Aichi (JP); Yoshiteru SAKAGUCHI, Aichi (JP)

(73) Assignee: KABUSHIKI KAISHA TOKAI-RIKA-DENKI-SEISAKUSHO, Aichi-ken (JP)

(21) Appl. No.: 19/561,537

(22) Filed: Mar. 10, 2026

(30) Foreign Application Priority Data
Mar. 17, 2025 (JP) 2025-042739

(51) Int. Cl. B60R 22/46

(52) U.S. Cl. CPC B60R 22/4628

(57) ABSTRACT

In a webbing take-up device, when a moving member is guided and moved in a cylinder, a webbing is taken up onto a spool. When a first micro gas generator is activated and supplies gas into the cylinder, the moving member moves. When a second micro gas generator is activated and supplies gas into the cylinder, the moving member moves. Therefore, the moving member may be moved by the first micro gas generator and by the second micro gas generator.

### CROSS-REFERENCE TO RELATED APPLICATION

This application is based on and claims priority under 35 USC 119 from Japanese Patent Application No. 2025-42739 filed on Mar. 17, 2025, the disclosure of which is incorporated by reference herein.

### BACKGROUND

### Technical Field

The present invention relates to a webbing take-up device in which a moving member is moved and a spool is rotated in a take-up direction.

### Related Art

In a webbing take-up device recited in Japanese Patent Application Laid-Open (JP-A) No. 2017-218093, when a micro gas generator (MGG) supplies gas to a cylinder, a moving member is guided and moved in the cylinder, and a spool is rotated in the take-up direction.

In this webbing take-up device, the moving member is moved by the MGG alone.

### SUMMARY

In consideration of the situation described above, an object of the present invention is to provide a webbing take-up device in which a moving member may be moved by a first supply mechanism and by a second supply mechanism.

A webbing take-up device according to a first aspect of the present invention includes: a spool that is rotated in a take-up direction, a webbing applied to a vehicle occupant being taken up onto the spool; a moving member that, when moved, rotates the spool in the take-up direction; a guide member at which the moving member is guided and moved; a first supply mechanism that is activated and supplies gas to the guide member for moving the moving member; and a second supply mechanism that is activated and supplies gas to the guide member for moving the moving member.

In the webbing take-up device according to the first aspect of the present invention, the spool is rotated in the take-up direction and the webbing applied to the occupant is taken up onto the spool. When the moving member is guided by the guide member and moved, the spool is rotated in the take-up direction.

When the first supply mechanism is activated and supplies the gas to the guide member, the moving member is moved. The moving member is also moved when the second supply mechanism is activated and supplies the gas to the guide member. Thus, the moving member may be moved by the first supply mechanism and by the second supply mechanism.

In a webbing take-up device according to a second aspect of the present invention, in the webbing take-up device according to the first aspect of the present invention, the first supply mechanism can be switched between activation and non-activation, and the second supply mechanism can be switched between activation and non-activation.

In the webbing take-up device according to the second aspect of the present invention, the first supply mechanism is switched between activation and non-activation, and the second supply mechanism is switched between activation and non-activation. Consequently, a movement force from the gas on the moving member may be switched, and a take-up force on the webbing toward the spool may be switched.

In a webbing take-up device according to a third aspect of the present invention, the webbing take-up device according to the first aspect or second aspect of the present invention further includes: a first supply channel through which the first supply mechanism supplies gas to the guide member; and a second supply channel through which the second supply mechanism supplies gas to the guide member, wherein: when the first supply mechanism is activated and the second supply mechanism is not activated, the second supply channel is sealed, and when the first supply mechanism is not activated and the second supply mechanism is activated, the first supply channel is sealed.

In the webbing take-up device according to the third aspect of the present invention, the first supply mechanism supplies the gas to the guide member via the first supply channel, and the second supply mechanism supplies the gas to the guide member via the second supply channel.

When the first supply mechanism is being activated and the second supply mechanism is not being activated, the second supply channel is sealed off. Therefore, gas from the first supply mechanism may be inhibited from reaching the second supply mechanism.

When the first supply mechanism is not being activated and the second supply mechanism is being activated, the first supply channel is sealed off. Therefore, gas from the second supply mechanism may be inhibited from reaching the first supply mechanism.

In a webbing take-up device according to a fourth aspect of the present invention, the webbing take-up device according to the third aspect of the present invention further includes: a first sealing member that seals the first supply channel; and a second sealing member that seals the second supply channel, wherein: when the first supply mechanism is activated and the second supply mechanism is not activated, sealing of the first supply channel by the first sealing member is released, and when the first supply mechanism is not activated and the second supply mechanism is activated, sealing of the second supply channel by the second sealing member is released.

In the webbing take-up device according to the fourth aspect of the present invention, the first sealing member seals off the first supply channel and the second sealing member seals off the second supply channel.

When the first supply mechanism is being activated and the second supply mechanism is not being activated, the sealing of the first supply channel by the first sealing member is released. Accordingly, the second sealing member may seal off the second supply channel.

When the first supply mechanism is not being activated and the second supply mechanism is being activated, the sealing of the second supply channel by the second sealing member is released. Accordingly, the first sealing member may seal off the first supply channel.

In a webbing take-up device according to a fifth aspect of the present invention, the webbing take-up device according to the third aspect of the present invention further includes a sealing member that: when the first supply mechanism is activated and the second supply mechanism is not activated, seals the second supply channel and does not seal the first supply channel, and when the first supply mechanism is not activated and the second supply mechanism is activated, seals the first supply channel and does not seal the second supply channel.

In the webbing take-up device according to the fifth aspect of the present invention, when the first supply mechanism is being activated and the second supply mechanism is not being activated, the sealing member does not seal the first supply channel but does seal the second supply channel. Thus, the second supply channel may be sealed off.

When the first supply mechanism is not being activated and the second supply mechanism is being activated, the sealing member does not seal the second supply channel but does seal the first supply channel. Thus, the first supply channel may be sealed off.

In a webbing take-up device according to a sixth aspect of the present invention, in the webbing take-up device according to any one of the first to fifth aspects of the present invention, the first supply mechanism and the second supply mechanism are integrated with one another and attached to the guide member.

In the webbing take-up device according to the sixth aspect of the present invention, the first supply mechanism and second supply mechanism are made integral and are attached to the guide member. Therefore, the first supply mechanism and second supply mechanism may be attached to the guide member easily.

In a webbing take-up device according to a seventh aspect of the present invention, the webbing take-up device according to any one of the first to sixth aspects of the present invention further includes a support body that supports the spool, the first supply mechanism and the second supply mechanism being attached to the support body.

In the webbing take-up device according to the seventh aspect of the present invention, the support body supports the spool.

In this aspect, the first supply mechanism and the second supply mechanism are attached to the support body. Therefore, vibrations caused by the first supply mechanism and the second supply mechanism may be suppressed.

### BRIEF DESCRIPTION OF THE DRAWINGS

Exemplary embodiments of the present invention will be described in detail based on the following figures, wherein:

FIG. 1 is a perspective view in which a webbing take-up device according to a first exemplary embodiment of the present invention is viewed diagonally from the front-left;

FIG. 2 is a perspective view in which the webbing take-up device according to the first exemplary embodiment of the present invention is viewed diagonally from the rear-right;

FIG. 3A is a sectional diagram, viewed from the left, showing the whole of a pre-tensioner mechanism of the webbing take-up device according to the first exemplary embodiment of the present invention;

FIG. 3B is a sectional diagram, viewed from the left, in which principal portions of the pre-tensioner mechanism of the webbing take-up device according to the first exemplary embodiment of the present invention are magnified;

FIG. 4 is a perspective view in which the interior of a supply unit of the webbing take-up device according to the first exemplary embodiment of the present invention is viewed diagonally from the rear-right;

FIG. 5A is a sectional diagram, viewed from the right, showing the supply unit of the webbing take-up device according to the first exemplary embodiment of the present invention prior to activation of a first MGG and a second MGG;

FIG. 5B is a sectional diagram, viewed from the right, showing the supply unit of the webbing take-up device according to the first exemplary embodiment of the present invention when the second MGG is activated;

FIG. 6A is a sectional diagram, viewed from the right, showing a supply unit of a webbing take-up device according to a second exemplary embodiment of the present invention prior to activation of a first MGG and a second MGG;

FIG. 6B is a sectional diagram, viewed from the right, showing the supply unit of the webbing take-up device according to the second exemplary embodiment of the present invention when the first MGG is activated;

FIG. 7A is a sectional diagram, viewed from the right, showing a supply unit of a webbing take-up device according to a third exemplary embodiment of the present invention prior to activation of a first MGG and a second MGG;

FIG. 7B is a sectional diagram, viewed from the right, showing the supply unit of the webbing take-up device according to the third exemplary embodiment of the present invention when the second MGG is activated;

FIG. 8A is an elevation view showing a first valve (or second valve) of the webbing take-up device according to the third exemplary embodiment of the present invention;

FIG. 8B is a side view showing the first valve (or second valve) of the webbing take-up device according to the third exemplary embodiment of the present invention; and

FIG. 9 is a sectional diagram, viewed from the right, of the interior of a supply unit of a webbing take-up device according to a fourth exemplary embodiment of the present invention.

### DETAILED DESCRIPTION

### First Exemplary Embodiment

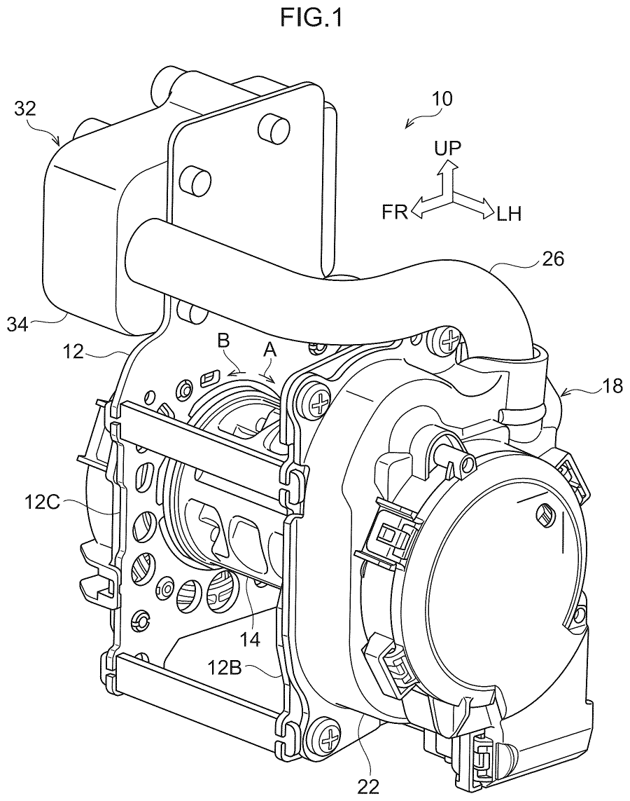

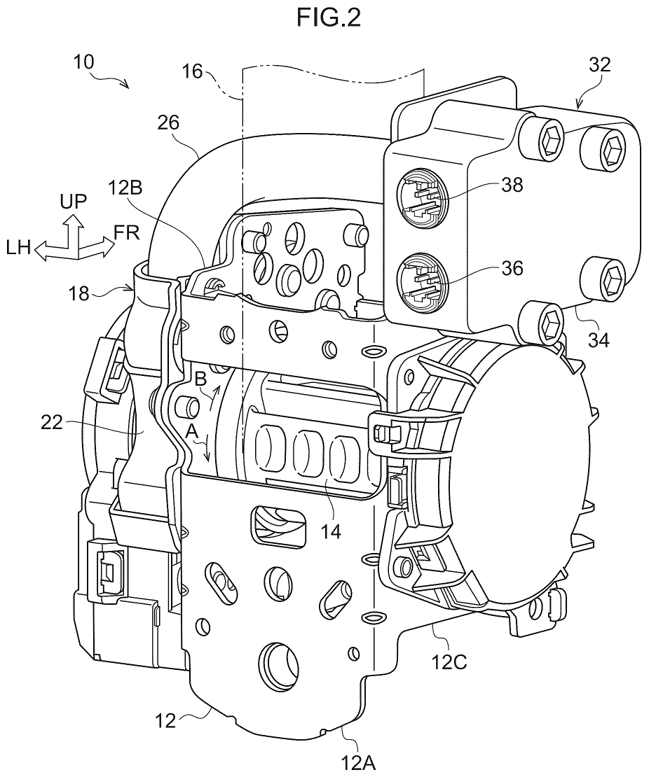

FIG. 1 shows a perspective view in which a webbing take-up device 10 according to a first exemplary embodiment of the present invention is viewed diagonally from a front-left side. FIG. 2 shows a perspective view in which the webbing take-up device 10 is viewed diagonally from the rear-right side. In these drawings, forward of the webbing take-up device 10 is indicated by the arrow FR, leftward of the webbing take-up device 10 is indicated by the arrow LH, and upward of the webbing take-up device 10 is indicated by the arrow UP.

The webbing take-up device 10 according to the present exemplary embodiment structures a seatbelt apparatus. The seatbelt apparatus is employed at a seat (not shown in the drawings) of a vehicle. A sensor is provided at the seat. The sensor detects the physique (for example, body weight) of a vehicle occupant sitting on the seat.

As shown in FIG. 1 and FIG. 2, a frame 12 with a substantial “U” shape in cross section is provided at the webbing take-up device 10. A rear plate 12A, a leg plate 12B and a leg plate 12C are provided at, respectively, the rear side, left side and right side of the frame 12. An upper portion of the leg plate 12C projects upward. The upper portion of the leg plate 12C is disposed further to the upper side relative to the leg plate 12B.

A substantially cylinder-shaped spool 14 is rotatably supported between the leg plate 12B and leg plate 12C of the frame 12. An axial direction of the spool 14 is set to the left-and-right direction.

A long, belt-shaped webbing 16 is wound onto the spool 14 from a length direction proximal end side of the webbing 16. The spool 14 is rotated in a take-up direction A (see FIG. 1) and the webbing 16 is taken up onto the spool 14. The spool 14 is rotated in a pull-out direction (see FIG. 1 and the like) and the webbing 16 is pulled out from the spool 14. The webbing 16 is pulled out from the spool 14 to the upper side and is applied to the occupant sitting on the seat.

A pre-tensioner mechanism 18 is provided spanning from the left side to the upper side of the frame 12.

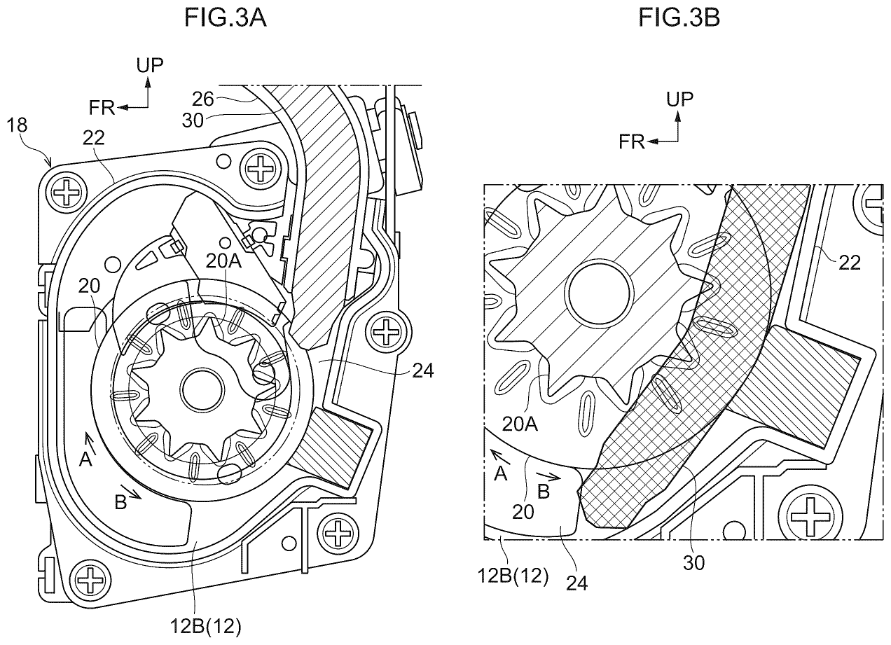

A substantially cylinder-shaped rotary member 20 fabricated of metal (see FIG. 3A) is provided at the pre-tensioner mechanism 18. The rotary member 20 is disposed coaxially with the spool 14 at the left side of the spool 14, and is linked to the spool 14 to be integrally rotatable therewith. Plural engaging teeth 20A with substantially triangular column shapes are integrally provided at the outer periphery of an axial direction middle portion of the rotary member 20. The engaging teeth 20A serve as an engaging portion. The plural engaging teeth 20A are disposed equidistantly in the circumferential direction of the rotary member 20. The engaging teeth 20A protrude to diametric direction outer sides of the rotary member 20. Dimensions of the engaging teeth 20A in the circumferential direction of the rotary member 20 decrease towards the diametric direction outer sides of the rotary member 20. Both of axial direction end portions of the rotary member 20 coaxially increase in diameter. The engaging teeth 20A are disposed between the two axial direction end portions of the rotary member 20.

A cover plate 22 with a substantially cuboid box shape that is fabricated of metal is fixed to the left side of the frame 12. The cover plate 22 serves as a channel body. The interior of the cover plate 22 is open to the right side. A movement channel 24 is formed from a rear portion through a lower portion and a front portion to an upper portion of the interior of the cover plate 22. An inner periphery face of the cover plate 22 forms the movement channel 24.

A cylinder 26 with a substantial cylinder shape that is fabricated of metal is disposed at the upper side of the frame 12. The cylinder 26 serves as a guide member. An axial direction middle portion of the cylinder 26 is inflected at plural locations. An axial direction distal end portion of the cylinder 26 projects to the lower side and is fixed between a rear portion of the leg plate 12B of the frame 12 and a rear portion of the cover plate 22. The interior of an axial direction distal end portion of the cylinder 26 is open to the lower side in a region at the rear side of the upper side of the interior of the cover plate 22. A region at the axial direction proximal end side of the cylinder 26 projects to the right, and the interior of an axial direction proximal end portion of the cylinder 26 is open to the right.

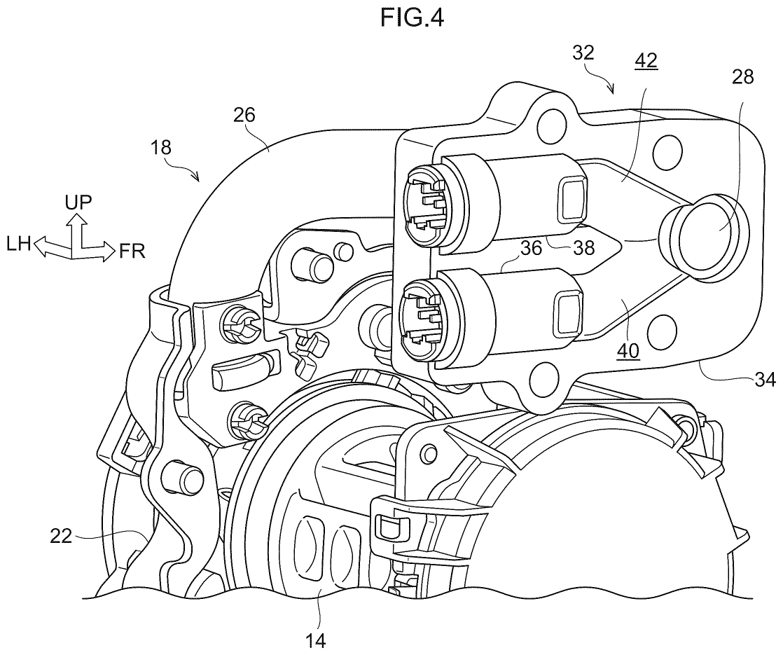

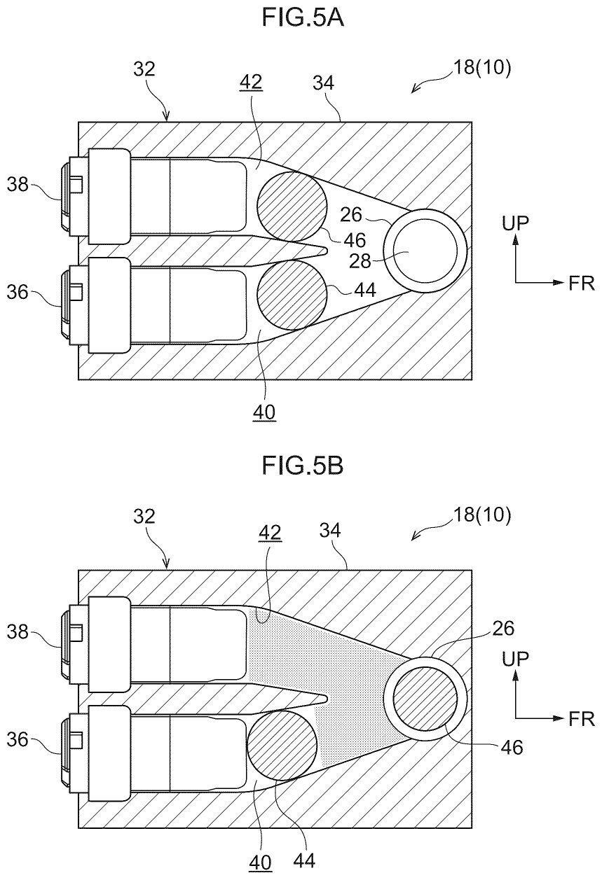

A piston 28 with a substantially cylindrical sealing portion shape (see FIG. 4 and FIG. 5A) is inserted into the axial direction proximal end portion of the cylinder 26. The piston 28 is fabricated of, for example, silicone rubber, and has resilience and sealing capability. The piston 28 is resiliently tightly fitted inside the cylinder 26. The piston 28 seals the interior of the cylinder 26.

A moving member 30 with a long, narrow, substantially cylindrical shape (see FIG. 3A) is disposed inside the cylinder 26 at the axial direction distal end side relative to the piston 28. The moving member 30 is fabricated of resin, is flexible, and is substantially tightly fitted inside the cylinder 26.

A supply unit 32 (see FIG. 5A) that serves as a supply device is disposed to the right side of the axial direction proximal end portion of the cylinder 26.

A supply body 34 with a substantially cuboid shape is provided at the supply unit 32. The supply body 34 is, for example, fabricated by die-casting or fabricated of a polyamide with glass fibers mixed in. The supply body 34 is attached to the right side of an upper portion of the leg plate 12C of the frame 12. The axial direction proximal end portion of the cylinder 26 is inserted into a front portion of the supply body 34 from the left thereof.

A first MGG 36 (first micro gas generator) that serves as a first supply mechanism is inserted into and fixed at the lower side of a rear portion of the supply body 34. When the first MGG 36 is activated, the first MGG 36 momentarily generates high-pressure gas. A second MGG 38 (second micro gas generator) that serves as a second supply mechanism is inserted into and fixed at the upper side of the rear portion of the supply body 34. When the second MGG 38 is activated, the second MGG 38 momentarily generates high-pressure gas. An output (generated gas amount) of the second MGG 38 is smaller than an output (generated gas amount) of the first MGG 36.

A first supply channel 40 with a circular shape in cross section is formed in the supply body 34. The first supply channel 40 extends substantially in the front-and-rear direction and puts the first MGG 36 and the interior of the axial direction proximal end portion of the cylinder 26 into fluid communication. A second supply channel 42 with a circular shape in cross section is also formed in the supply body 34. The second supply channel 42 extends substantially in the front-and-rear direction and puts the second MGG 38 and the interior of the axial direction proximal end portion of the cylinder 26 into fluid communication. A region at the front side of the first supply channel 40 and a region at the front side of the second supply channel 42 are united.

A first sealing member 44 with a spherical shape is inserted into a region at the rear side of the first supply channel 40. The first sealing member 44 is fabricated of, for example, silicone rubber, and has resilience and sealing capability. The first sealing member 44 is resiliently tightly fitted in the first supply channel 40 and seals off the first supply channel 40. A second sealing member 46 with a spherical shape is inserted into a region at the rear side of the second supply channel 42. The second sealing member 46 is fabricated of, for example, silicone rubber, and has resilience and sealing capability. The second sealing member 46 is resiliently tightly fitted in the second supply channel 42 and seals off the second supply channel 42.

Now, operation of the present exemplary embodiment is described.

In the webbing take-up device 10 with the structure described above, when the sensor at the seat has detected that a vehicle occupant has a large physique, at a time of collision of the vehicle (when a collision is detected), the first MGG 36 of the pre-tensioner mechanism 18 is activated (the second MGG 38 is not activated), and the first MGG 36 momentarily supplies high-pressure gas to the first supply channel 40 of the supply body 34. The first sealing member 44 of the first supply channel 40 is moved into the cylinder 26 by the pressure of the gas (releasing sealing of the first supply channel 40), and the first sealing member 44 and the piston 28 in the cylinder 26 are guided by the cylinder 26 while being moved toward the axial direction distal end side of the cylinder 26.

When the sensor at the seat has detected that a vehicle occupant has a small physique, at a time of collision of the vehicle (when a collision is detected), the second MGG 38 of the pre-tensioner mechanism 18 is activated (the first MGG 36 is not activated), and the second MGG 38 momentarily supplies high-pressure gas to the second supply channel 42 of the supply body 34. The second sealing member 46 of the second supply channel 42 is moved into the cylinder 26 by the pressure of the gas (releasing sealing of the second supply channel 42), and the second sealing member 46 and the piston 28 in the cylinder 26 are guided by the cylinder 26 while being moved toward the axial direction distal end side of the cylinder 26 (see FIG. 5B).

When the piston 28 moves toward the axial direction distal end side of the cylinder 26 while being guided by the cylinder 26, the moving member 30 in the cylinder 26 is pushed by the piston 28, and the moving member 30 moves toward the axial direction distal end side of the cylinder 26 while being guided by the cylinder 26. As a result, the moving member 30 projects to the lower side from the axial direction distal end side of the cylinder 26. Then, the moving member 30 moves inside the cover plate 22 along the inner periphery face of the cover plate 22. The moving member 30 moves along the movement channel 24 in the cover plate 22, moving to the lower side through a rear portion of the interior of the cover plate 22, moving to the front side through a lower portion of the interior of the cover plate 22, moving to the upper side through a front portion of the interior of the cover plate 22, and moving to the rear side through an upper portion of the interior of the cover plate 22.

When the moving member 30 is moving to the lower side through the rear portion of the interior of the cover plate 22, the moving member 30 passes between a rear portion of the axial direction middle portion of the rotary member 20 and the inner periphery face of the rear portion of the cover plate 22, and the engaging teeth 20A at the rear portion of the rotary member 20 are engaged with (bite into) the moving member 30. As a result (see FIG. 3), the rotary member 20 is rotated in the take-up direction A by the moving member 30, and the spool 14 is rotated in the take-up direction A integrally with the rotary member 20. Consequently, the webbing 16 is taken up onto the spool 14 and a restraining force on the occupant from the webbing 16 is increased. At positions after the moving member 30 has passed between the rear portion of the axial direction middle portion of the rotary member 20 and the inner periphery face of the rear portion of the cover plate 22, the moving member 30 does not engage with the engaging teeth 20A.

When a vehicle occupant has a large physique, the first MGG 36 with the larger output is activated and a movement force on the moving member 30 is larger. Therefore, rotary force on the rotary member 20 and the spool 14 in the take-up direction A is larger, and a take-up force of the webbing 16 onto the spool 14 is larger (higher power). Therefore, a restraining force from the webbing 16 on the vehicle occupant with the large physique may be suitable.

When a vehicle occupant has a small physique, the second MGG 38 with the smaller output is activated and a movement force on the moving member 30 is smaller. Therefore, rotary force on the rotary member 20 and the spool 14 in the take-up direction A is smaller, and a take-up force of the webbing 16 onto the spool 14 is smaller (reduced power). Therefore, a restraining force from the webbing 16 on the vehicle occupant with the small physique may be suitable.

The moving member 30 can be moved by the first MGG 36 being activated and supplying gas into the cylinder 26. The moving member 30 can also be moved by the second MGG 38 being activated and supplying gas into the cylinder 26. Thus, the moving member 30 may be moved by the first MGG 36 and by the second MGG 38.

The first MGG 36 can be switched between activation and non-activation, and the second MGG 38 can be switched between activation and non-activation. Therefore, the movement force on the moving member 30 from the gas may be switched, and the take-up force of the webbing 16 onto the spool 14 may be switched. In addition, because the first MGG 36 and second MGG 38 are just switched between activation and non-activation, additional components or structures may not be required at the rotary member 20 and bearings of the rotary member 20.

When the first MGG 36 is activated and the second MGG 38 is not activated, sealing of the first supply channel 40 by the first sealing member 44 is released but the second supply channel 42 is sealed by the second sealing member 46. Therefore, the gas from the first MGG 36 may be inhibited from reaching the second MGG 38.

When the first MGG 36 is not activated and the second MGG 38 is activated, sealing of the second supply channel 42 by the second sealing member 46 is released but the first supply channel 40 is sealed by the first sealing member 44. Therefore, the gas from the second MGG 38 may be inhibited from reaching the first MGG 36.

The first MGG 36 and second MGG 38 are attached to the cylinder 26 by the first MGG 36 and second MGG 38 being integrated in the supply unit 32 and the supply unit 32 being attached to the cylinder 26. Therefore, the first MGG 36 and second MGG 38 may be attached to the cylinder 26 easily. In addition, because electrically wiring the supply unit 32 is sufficient for wiring up the first MGG 36 and second MGG 38, wiring may be easy.

The supply unit 32 (the first MGG 36 and second MGG 38) is attached to the leg plate 12C of the frame 12. Therefore, vibrations of the cylinder 26 caused by the first MGG 36 and the second MGG 38 may be suppressed.

### Second Exemplary Embodiment

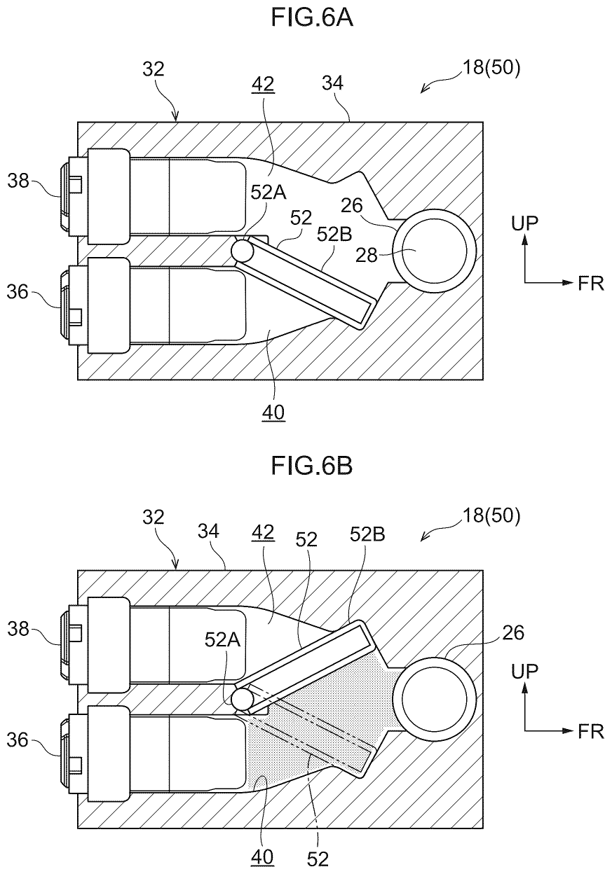

FIG. 6A is a sectional diagram, viewed from the right, showing the supply unit 32 of a webbing take-up device 50 according to a second exemplary embodiment of the present invention.

The webbing take-up device 50 according to the present exemplary embodiment has substantially the same structure as in the first exemplary embodiment described above but differs in the following respects.

As shown in FIG. 6A, in the pre-tensioner mechanism 18 of the webbing take-up device 50 according to the present exemplary embodiment, the first sealing member 44 and second sealing member 46 according to the first exemplary embodiment described above are not provided in the supply body 34 of the supply unit 32.

In the supply body 34, a plate-shaped sealing valve 52 that serves as a sealing member is provided. The sealing valve 52 is, for example, fabricated by die-casting or fabricated of iron. A turning axle 52A is integrally provided at a rear end of the sealing valve 52. The turning axle 52A of the sealing valve 52 is turnably supported at a region in the supply body 34 between the first MGG 36 and the second MGG 38. The sealing valve 52 extends to front side regions (an integrated region) of the first supply channel 40 and second supply channel 42 in the supply body 34. The sealing valve 52 is turnable in the vertical direction between a lower side turning position and an upper side turning position. A sealing layer 52B is provided to surround regions of the sealing valve 52 apart from the rear end. The sealing layer 52B is fabricated of, for example, silicone rubber, and has resilience and sealing capability. When the sealing valve 52 is disposed at the lower side turning position, the sealing valve 52 seals off the first supply channel 40 and opens up the second supply channel 42 (see FIG. 6A). When the sealing valve 52 is disposed at the upper side turning position, the sealing valve 52 seals off the second supply channel 42 and opens up the first supply channel 40 (see FIG. 6B).

When the sensor at the seat has detected that a vehicle occupant has a large physique, at a time of collision of the vehicle (when a collision is detected), the first MGG 36 of the pre-tensioner mechanism 18 is activated (the second MGG 38 is not activated), and the first MGG 36 momentarily supplies high-pressure gas to the first supply channel 40 of the supply body 34. The sealing valve 52 is disposed to the upper side turning position by the pressure of the gas (opening up the first supply channel 40), and the piston 28 in the cylinder 26 is guided by the cylinder 26 while being moved toward the axial direction distal end side of the cylinder 26.

When the sensor at the seat has detected that a vehicle occupant has a small physique, at a time of collision of the vehicle (when a collision is detected), the second MGG 38 of the pre-tensioner mechanism 18 is activated (the first MGG 36 is not activated), and the second MGG 38 momentarily supplies high-pressure gas to the second supply channel 42 of the supply body 34. The sealing valve 52 is disposed to the lower side turning position by the pressure of the gas (opening up the second supply channel 42), and the piston 28 in the cylinder 26 is guided by the cylinder 26 while being moved toward the axial direction distal end side of the cylinder 26.

Therefore, in the present exemplary embodiment, the same operation and effects as in the first exemplary embodiment described above are realized.

In particular, when the first MGG 36 is activated and the second MGG 38 is not activated, the sealing valve 52 does not seal off the first supply channel 40 but does seal off the second supply channel 42. Therefore, the gas from the first MGG 36 may be inhibited from reaching the second MGG 38.

Alternatively, when the first MGG 36 is not activated and the second MGG 38 is activated, the sealing valve 52 does not seal off the second supply channel 42 but does seal off the first supply channel 40. Therefore, the gas from the second MGG 38 may be inhibited from reaching the first MGG 36.

### Third Exemplary Embodiment

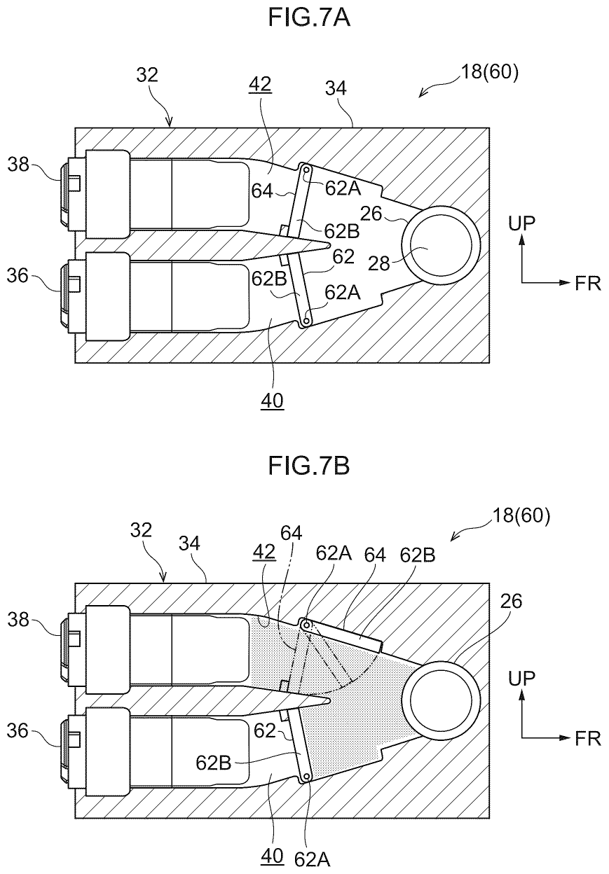

FIG. 7A is a sectional diagram, viewed from the right, showing the supply unit 32 of a webbing take-up device 60 according to a third exemplary embodiment of the present invention.

The webbing take-up device 60 according to the present exemplary embodiment has substantially the same structure as in the first exemplary embodiment described above but differs in the following respects.

As shown in FIG. 7A, in the pre-tensioner mechanism 18 of the webbing take-up device 60 according to the present exemplary embodiment, the first sealing member 44 and second sealing member 46 according to the first exemplary embodiment described above are not provided in the supply body 34 of the supply unit 32.

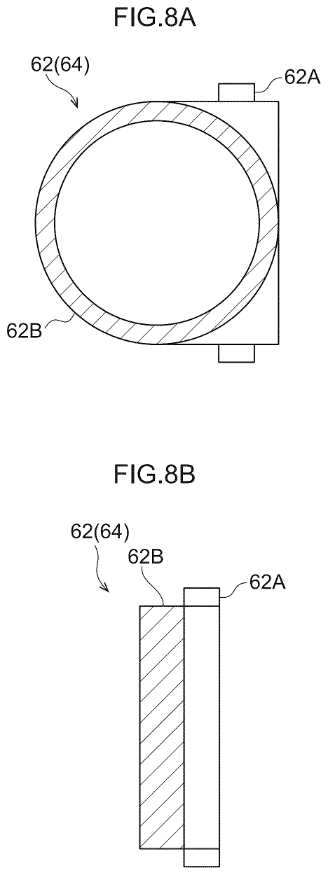

In the supply body 34, a substantially circular plate-shaped first valve 62 (see FIG. 8A and FIG. 8B) that serves as a first sealing member is provided in a region at the rear side of the first supply channel 40. The first valve 62 is fabricated of, for example, die-cast metal or of iron. A turning axle 62A is integrally provided at one end of the first valve 62. The turning axle 62A of the first valve 62 is turnably supported in the supply body 34 at the lower side of the first supply channel 40. A sealing layer 62B is provided to surround regions of the first valve 62 apart from the one end. The sealing layer 62B is fabricated of, for example, silicone rubber, and has resilience and sealing capability. The first valve 62 is turnable in the vertical direction between a sealing position at the upper side and an open position at the lower side. The first valve 62 is disposed at the sealing position and seals off the first supply channel 40.

A second valve 64 that serves as a second sealing member is provided in a region at the rear side of the second supply channel 42. The second valve 64 has a similar structure to the first valve 62. At the second valve 64, another of the turning axle 62A is turnably supported in the supply body 34 at the upper side of the second supply channel 42. The second valve 64 is turnable in the vertical direction between a sealing position at the lower side and an open position at the upper side. The second valve 64 is disposed at the sealing position and seals off the second supply channel 42.

When the sensor at the seat has detected that a vehicle occupant has a large physique, at a time of collision of the vehicle (when a collision is detected), the first MGG 36 of the pre-tensioner mechanism 18 is activated (the second MGG 38 is not activated), and the first MGG 36 momentarily supplies high-pressure gas to the first supply channel 40 of the supply body 34. The first valve 62 of the first supply channel 40 is turned to the open position by the pressure of the gas (opening up the first supply channel 40), and the piston 28 in the cylinder 26 is guided by the cylinder 26 while being moved toward the axial direction distal end side of the cylinder 26.

When the sensor at the seat has detected that a vehicle occupant has a small physique, at a time of collision of the vehicle (when a collision is detected), the second MGG 38 of the pre-tensioner mechanism 18 is activated (the first MGG 36 is not activated), and the second MGG 38 momentarily supplies high-pressure gas to the second supply channel 42 of the supply body 34. The second valve 64 of the second supply channel 42 is turned to the open position by the pressure of the gas (opening up the second supply channel 42), and the piston 28 in the cylinder 26 is guided by the cylinder 26 while being moved toward the axial direction distal end side of the cylinder 26 (see FIG. 7B).

Therefore, in the present exemplary embodiment, the same operation and effects as in the first exemplary embodiment described above are realized.

When the first MGG 36 is activated and the second MGG 38 is not activated, the sealing of the first supply channel 40 by the first valve 62 is released but the second supply channel 42 is sealed by the second valve 64. Therefore, the gas from the first MGG 36 may be inhibited from reaching the second MGG 38.

Alternatively, when the first MGG 36 is not activated and the second MGG 38 is activated, the sealing of the second supply channel 42 by the second valve 64 is released but the first supply channel 40 is sealed by the first valve 62. Therefore, the gas from the second MGG 38 may be inhibited from reaching the first MGG 36.

In the first to third exemplary embodiments described above, the output of the first MGG 36 is larger and the output of the second MGG 38 is smaller. However, the output of the first MGG 36 and the output of the second MGG 38 may be the same. For example, the output of the first MGG 36 and the output of the second MGG 38 may both be small, in which case, when a vehicle occupant has a large physique, the first MGG 36 and the second MGG 38 are activated, and when an occupant has a small physique, either the first MGG 36 or the second MGG 38 is activated.

### Fourth Exemplary Embodiment

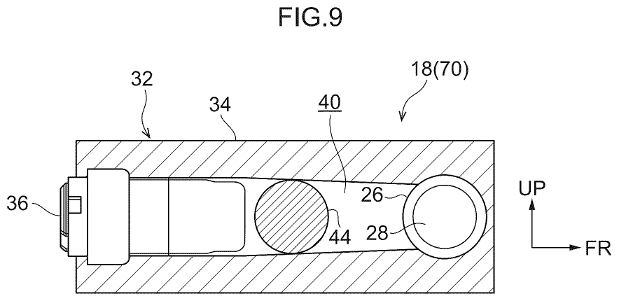

FIG. 9A is a sectional diagram, viewed from the right, showing the supply unit 32 of a webbing take-up device 70 according to a fourth exemplary embodiment of the present invention.

The webbing take-up device 70 according to the present exemplary embodiment has substantially the same structure as the first exemplary embodiment described above but differs in the following respects.

As shown in FIG. 9, in the pre-tensioner mechanism 18 of the webbing take-up device 70 according to the present exemplary embodiment, the second MGG 38 is not provided at the supply unit 32 and the second supply channel 42 and second sealing member 46 are not provided in the supply body 34.

At a time of collision of the vehicle (when a collision is detected), the first MGG 36 of the pre-tensioner mechanism 18 is always activated. Therefore, restraining force on a vehicle occupant from the webbing 16 may be increased.

The supply unit 32 according to the first exemplary embodiment, second exemplary embodiment or third exemplary embodiment described above may be easily replaced with the supply unit 32 according to the present exemplary embodiment. Therefore, it may be easy to switch between a pre-tensioner mechanism 18 in which the amount of increase in restraining force on the occupant from the webbing 16 may be altered and a pre-tensioner mechanism 18 in which the amount of increase in restraining force on the occupant from the webbing 16 is fixed.

What is claimed is:

1. A webbing take-up device comprising:
a spool that is rotated in a take-up direction, a webbing applied to a vehicle occupant being taken up onto the spool;
a moving member that, when moved, rotates the spool in the take-up direction;
a guide member at which the moving member is guided and moved;
a first supply mechanism that is activated and supplies gas to the guide member for moving the moving member; and
a second supply mechanism that is activated and supplies gas to the guide member for moving the moving member.

2. The webbing take-up device according to claim 1, wherein:
the first supply mechanism can be switched between activation and non-activation, and
the second supply mechanism can be switched between activation and non-activation.

3. The webbing take-up device according to claim 1, further comprising:
a first supply channel through which the first supply mechanism supplies gas to the guide member; and
a second supply channel through which the second supply mechanism supplies gas to the guide member,
wherein:
when the first supply mechanism is activated and the second supply mechanism is not activated, the second supply channel is sealed, and
when the first supply mechanism is not activated and the second supply mechanism is activated, the first supply channel is sealed.

4. The webbing take-up device according to claim 3, further comprising:
a first sealing member that seals the first supply channel; and
a second sealing member that seals the second supply channel,
wherein:
when the first supply mechanism is activated and the second supply mechanism is not activated, sealing of the first supply channel by the first sealing member is released, and
when the first supply mechanism is not activated and the second supply mechanism is activated, sealing of the second supply channel by the second sealing member is released.

5. The webbing take-up device according to claim 3, further comprising a sealing member that:
when the first supply mechanism is activated and the second supply mechanism is not activated, seals the second supply channel and does not seal the first supply channel, and
when the first supply mechanism is not activated and the second supply mechanism is activated, seals the first supply channel and does not seal the second supply channel.

6. The webbing take-up device according to claim 1, wherein the first supply mechanism and the second supply mechanism are integrated with one another and attached to the guide member.

7. The webbing take-up device according to claim 1, further comprising a support body that supports the spool, the first supply mechanism and the second supply mechanism being attached to the support body.

8. The webbing take-up device according to claim 1, wherein a gas supply amount of the first supply mechanism and a gas supply amount of the second supply mechanism are different or are the same.

9. The webbing take-up device according to claim 1, further comprising a supply body to which the first supply mechanism and the second supply mechanism are attached, a first supply channel and a second supply channel being provided at the supply body,
the first supply mechanism supplying gas through the first supply channel to the guide member, and
the second supply mechanism supplying gas through the second supply channel to the guide member.

10. The webbing take-up device according to claim 1, wherein the first supply mechanism is switched between activation and non-activation, and the second supply mechanism is switched between activation and non-activation, in accordance with a physique of the vehicle occupant.
